(19) United States
(12) Patent Application Publication
(10) Pub. No.: US 2012/0109364 A1
(43) Pub. Date: May 3, 2012

(54) Mask Conveying System And Mask Conveying Adapter

(75) Inventors: Hisashi HARADA, Mie (JP); Hiroshi Motoki, Mie (JP); Takeshi Takakura, Mie (JP); Yasushi Yamanaka, Mie (JP)

(73) Assignee: Kabushiki Kaisha Toshiba, Minato-ku (JP)

(21) Appl. No.: 13/237,352

(22) Filed: Sep. 20, 2011

(30) Foreign Application Priority Data
Nov. 2, 2010 (JP) 2010-246585

(51) Int. Cl. G06F 7/00; B65D 85/00

(52) U.S. Cl. 700/230; 206/710

(57) ABSTRACT

According to one embodiment, a mask conveying system includes a stocker, a conveyance path, a storage container, a conveying apparatus, and a control device. The storage container for wafer conveyance has the same structure as the storage container for mask conveyance. The control device determines whether or not the storage container is for mask conveyance when the storage container is introduced into the stocker in an exposure area or the stocker in a mask inspection area, and controls the conveying apparatus such that the storage container is conveyed to the stocker that does not have the storage container introduced when the storage container is for mask conveyance.

### CROSS-REFERENCE TO RELATED APPLICATIONS

This application is based upon and claims the benefit of priority from Japanese Patent Application No. 2010-246585, filed on Nov. 2, 2010; the entire contents of which are incorporated herein by reference.

### FIELD

Embodiments described herein relate generally to a mask conveying system and a mask conveying adapter.

### BACKGROUND

In conventional facilities for manufacturing semiconductor devices, an exposure apparatus and a stocker that stores a plurality of photomasks used by the exposure apparatus are installed in an area where an exposure process is performed, in which the stocker is located near the exposure apparatus. Delivery of the photomask between the stocker and the exposure apparatus is performed by a mask conveying apparatus. The photomasks are mounted in an adapter capable of storing various types of photomasks and are stored in the stocker in a state of being mounted in the adapter.

Generally, when the photomask is used by the exposure apparatus, it causes a growing defect through exposure repetitions. When the defect grows to a certain size or larger, it is transferred onto a wafer as a pattern, and so the manufacturing yield of the semiconductor device is lowered. For this reason, inspection is periodically performed to check whether the photomask is usable in terms of quality by using a mask inspection apparatus.

Conventionally, when the mask inspection apparatus is located in the vicinity of the exposure apparatus, the photomask of the exposure apparatus can be conveyed to the mask inspection apparatus through the stocker. However, when the mask inspection apparatus is located at a position in which it is difficult for the mask conveying apparatus to convey the photomask, the photomask needs to be manually conveyed between the exposure apparatus and the mask inspection apparatus.

### BRIEF DESCRIPTION OF THE DRAWINGS

FIG. 1 is a diagram schematically illustrating an example of a semiconductor device manufacturing facility to which a mask conveying system according to an embodiment is applied;

FIGS. 2A to 2C are diagrams illustrating an example of a structure of a storage container;

FIG. 3 is an exploded perspective diagram illustrating an example of a mask conveying adapter for storing photomasks in a storage container;

FIGS. 4A and 4B are perspective diagrams schematically illustrating states of a storage container at the time of storage;

FIGS. 5A and 5B illustrate states of a storage container when a mask conveying adapter is stored;

FIG. 6 is a diagram schematically illustrating an example of a structure of a conveying apparatus;

FIG. 7 is a block diagram illustrating a functional configuration of a control device according to an embodiment;

FIG. 8 is a diagram illustrating an example of storage container registration information;

FIG. 9 is a flowchart illustrating an example of the procedure of a destination control process of a storage container according to an embodiment; and

FIG. 10 is a flowchart illustrating an example of a mask inspection procedure using the mask conveying system.

### DETAILED DESCRIPTION

In general, according to one embodiment, a mask conveying system that conveys a photomask, which is to be used in an exposure apparatus, between the exposure apparatus used in one of the manufacturing processes and a mask inspection apparatus which inspects the photomask used in the exposure apparatus is provided. The mask conveying system includes stockers, a conveyance path, a storage container, a conveying apparatus, and a control device. The mask conveying system is configured to sequentially convey the storage container to the stockers of processing areas. The stockers are located in the processing areas in which the apparatuses used in respective processes for manufacturing semiconductors are arranged. The conveyance path connects the stockers of the processing areas to one another. The storage container is capable of storing a predetermined number of wafers to be processed in the processing areas, and the storage container for wafer conveyance has the same structure as the storage container for mask conveyance. The conveying apparatus is movable along the conveyance path and is capable of conveying the storage container. The control device controls movement of the conveying apparatus on the conveyance path and includes a conveying apparatus control unit. The conveying apparatus control unit determines whether or not the storage container is the storage container for mask conveyance when the storage container is introduced into a first stocker of an exposure area in which the exposure apparatus is arranged, or into a second stocker of a mask inspection area in which the mask inspection apparatus is arranged, and controls the conveying apparatus such that the storage container is conveyed to the second or the first stocker that is other than the stocker having the stocker introduced.

Exemplary embodiments of a mask conveying system and a mask conveying adapter will be explained below in detail with reference to the accompanying drawings. The present invention is not limited to the following embodiments.

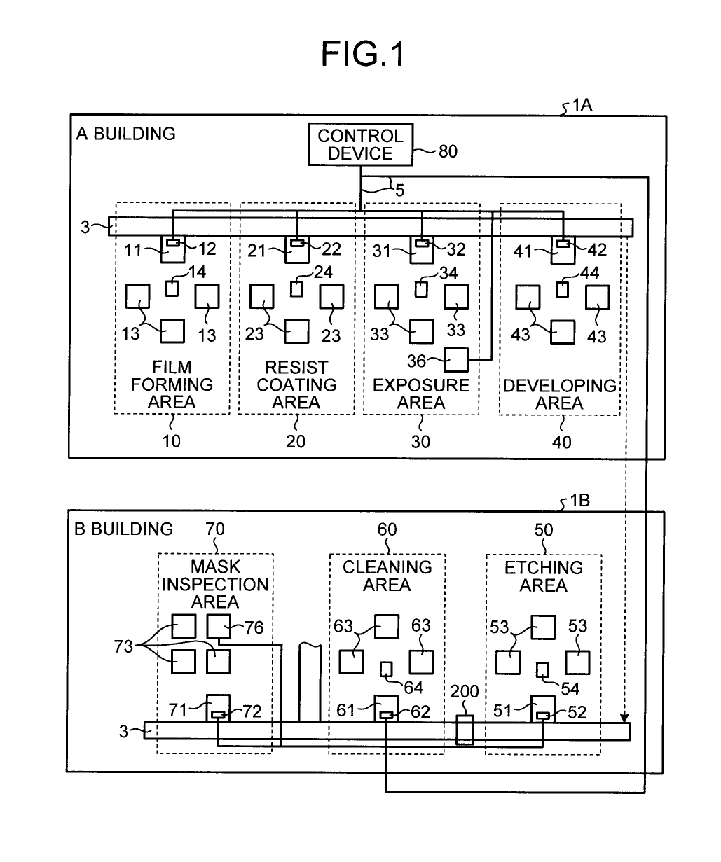

FIG. 1 is a diagram schematically illustrating an example of a semiconductor device manufacturing facility to which a mask conveying system according to an embodiment is applied. Here, exemplified is a case in which the semiconductor device manufacturing facility includes an A building 1A and a B building 1B, and processing apparatuses for manufacturing a semiconductor device are arranged in the A building 1A and the B building 1B. In this example, a facility, for conveying a wafer of a processing target object to a processing area in which each processing apparatus is arranged and for manufacturing a product, is employed as the semiconductor device manufacturing facility. Further, the A building 1A is illustrated to include a film forming area 10, a resist coating area 20, an exposure area 30, and a developing area 40, and the B building 1B is illustrated to include an etching area 50, a cleaning area 60, and a mask inspection area 70. In this example, it is assumed that a conveying system called an over head hoist transport (OHT) and a moving system of a linear driving type are employed. Thus, a rail 3 is installed on a ceiling surface as a conveying path so as to pass through between the processing areas of each building, and a conveying apparatus 200 moves along the rail 3. The rail 3 is also installed between the developing area 40 of the A building 1A and the etching area 50 of the B building 1B as indicated by an arrow in FIG. 1. Thus, the conveying apparatus 200 can move between the A building 1A and the B building 1B.

Stockers 11 to 71 for mounting a storage container storing the wafer of the processing target are located in portions of the processing areas 10 to 70 corresponding to an arrangement position of the rail 3, respectively. Processing apparatuses corresponding to the processing areas 10 to 70 are located in the vicinity of the stockers 11 to 71, respectively. For example, a film forming apparatus 13 is located in the film forming area 10, a resist coating apparatus 23 is located in the resist coating area 20, an exposure apparatus 33 is located in the exposure area 30, a developing apparatus 43 is located in the developing area 40, an etching apparatus 53 is located in the etching area 50, a cleaning apparatus 63 is located in the cleaning area 60, and a mask inspection apparatus 73 is located in the mask inspection area 70. Conveying apparatuses 14 to 64 for conveying the wafer from inside the storage container to the processing apparatuses are located in the film forming area 10, the resist coating area 20, the exposure area 30, the developing area 40, the etching area 50, and the cleaning area 60, respectively. Further, operation terminals 36 and 76 used by operators are located in the exposure area 30 and the mask inspection area 70, respectively.

A control device 80 is connected to controlled devices such as the processing apparatuses 13 to 73 and the conveying apparatuses 14 to 64 and 200 via a communication line 5. The control device 80 controls the overall operation of the semiconductor device manufacturing facility. For example, the conveying apparatus 200 moves according to a semiconductor device manufacturing process so as to convey the wafer to the film forming area 10, the resist coating area 20, the exposure area 30, the developing area 40, the etching area 50, and the cleaning area 60 in the described order, and each processing apparatus of each processing area performs processing on the wafer conveyed by the conveying apparatus 200. For the sake of processing, information necessary for controlling the controlled device is transmitted from the controlled device to the control device via the communication line 5. The control device 80 performs a calculation using the information to generate an instruction for controlling the controlled device, and transmits the instruction to the controlled device via the communication line 5. The control device 80 is also connected with the operation terminals 36 and 76 via the communication line 5.

The stockers 11 to 71 include storage container identification information reading units 12 to 72 that read storage container identification information which is found on the storage container and that notify the control device 80 of the read storage container identification information and the stocker identification information. Thus, the storage container identification information reading units 12 to 72 of the stockers are connected with the control device 80 via the communication line 5. The storage container identification information reading units 12 to 72 are bar code readers or two-dimensional code readers when the storage container identification storage unit located in the storage container is configured with a bar code or a two-dimensional code. The storage container identification information reading units 12 to 72 are radio tag reading devices when the storage container identification storage unit is configured with a radio tag.

In a general semiconductor device manufacturing facility, the wafer is conveyed by the conveying apparatus 200 moving along the rail 3. However, in the present embodiment, the photomask as well as the wafer is conveyed between the exposure apparatus 33 and the mask inspection apparatus 73. Thus, the photomask as well as the wafer is stored in the storage container conveyed by the conveying apparatus 200 as will be described later.

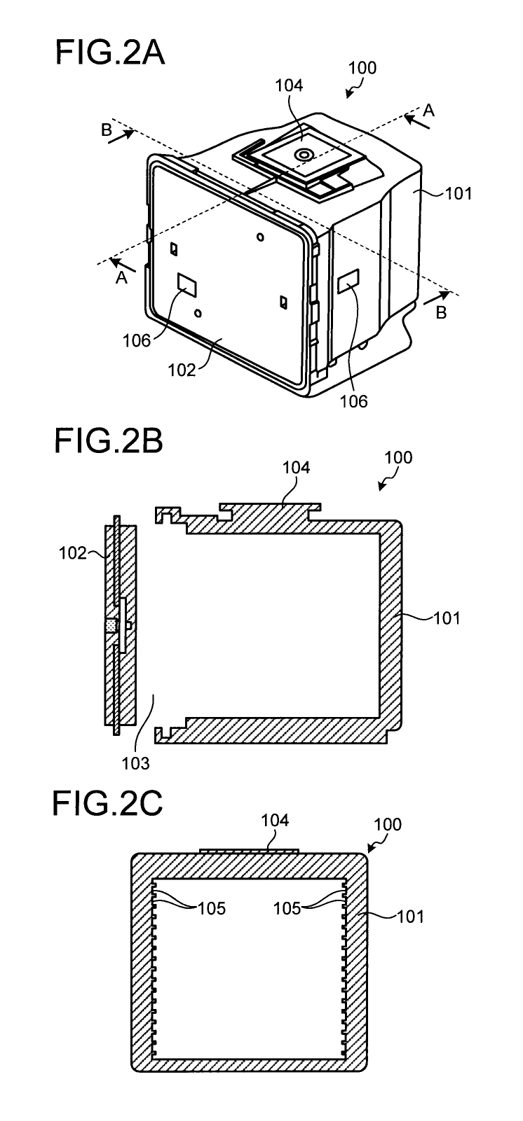

FIGS. 2A to 2C are diagrams illustrating an example of a structure of the storage container. FIG. 2A is a perspective diagram illustrating the appearance of the storage container, FIG. 2B is a cross-sectional view taken along the line A-A of FIG. 2A, and FIG. 2C is a cross-sectional view taken along the line B-B of FIG. 2A. As illustrated in FIGS. 2A to 2C, a storage container 100 has a rectangular parallelepiped shape whose inside is hollow. The storage container 100 includes a storage member 101 in which one surface of the rectangular parallelepiped becomes an opening 103 that allows a conveying target to be taken into or out of the storage container 100 and a cover member 102 attachable to the opening 103 of the storage member 101. The cover member 102 is attached to cover the opening 103 of the storage member 101 at the time of conveyance. Further, a connecting unit 104 connected with the conveying apparatus 200 is located on the upper portion of the storage container 100.

Grooves 105 capable of storing the wafers are located on the inner wall of the storage member 101 in a side-to-side direction when the opening 103 of the storage container 100 is viewed from the front. For example, the grooves 105 are located inside the storage member 101 to hold the number of wafers that can be manufactured in one lot which is one manufacturing unit in the manufacturing of semiconductor devices.

Further, a storage container identification storage unit 106 storing the storage container identification information for uniquely identifying storage container 100 within a system is located on storage container 100. For example, a bar code, a two-dimensional code, a radio tag, or the like may be used as the storage container identification storage unit 106.

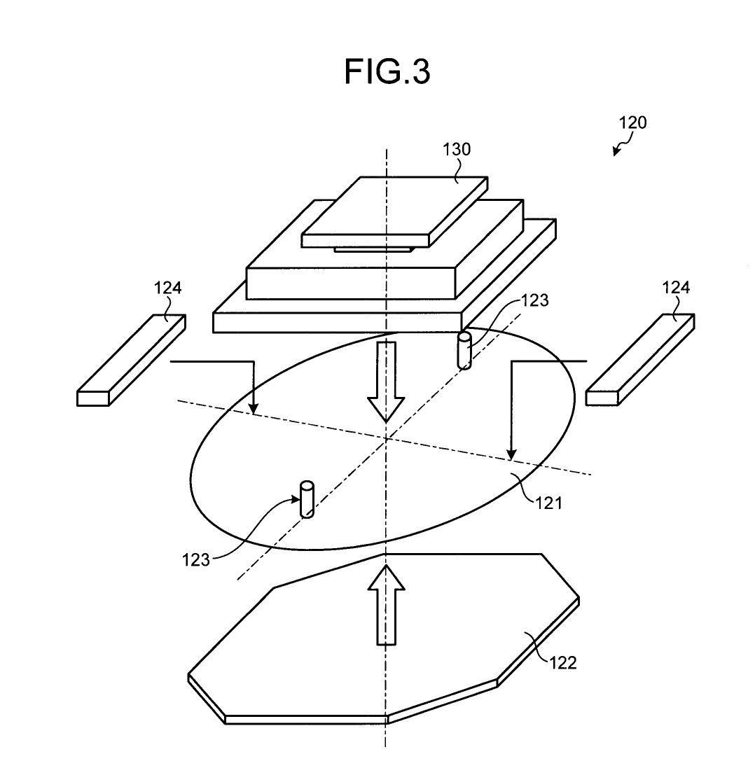

FIG. 3 is an exploded perspective diagram illustrating an example of a mask conveying adapter for storing the photomask in the storage container. The mask conveying adapter 120 includes a base plate 121 which is the same size as the wafer stored in the storage container 100, a back surface reinforcing plate 122 adhered to the back surface of the base plate 121 in the front-to-back direction on the base plate 121, guide pins 123 for preventing a photomask storage case 130 which stores the photomask therein from moving on the base plate 121, and guide bars 124 for preventing the photomask storage case 130 from moving on the base plate 121 in the side-to-side direction and preventing the base plate 121 from rotating in an in-plane direction when the mask conveying adapter 120 is stored in the storage container 100. In this example, the guide bars 124 are shaped to extend in a front-to-back direction of the base plate 121 (a depth direction of the storage container 100) and have a removable configuration. Here, the direction in which the mask conveying adapter 120 is taken into or out of the opening 103 of the storage container 100 is defined as the front-to-back direction of the base plate 121, and the direction perpendicular to the front to back direction (the depth direction) within the base plate 121 plane is defined as the side-to-side direction. The base plate 121 and the back surface reinforcing plate 122 configure the bottom plate, and the guide pins 123 and the guide bars 124 configure the support members.

In this example, the back surface reinforcing plate 122 has an octagonal shape but preferably includes a plate-like member of a polygonal shape having sides parallel to side surfaces of the storage container 100 in the front to back direction and the side-to-side direction when it is stored in the storage container 100. The mask conveying adapter 120 is stored in the storage container 100 so that the sides of the back surface reinforcing plate 122 can be parallel to the side surfaces of the storage container 100 in the front to back direction and the side-to-side direction. This placement prevents the bottom plate from rotating in the in-plane direction, and thus prevents the photomasks from being damaged.

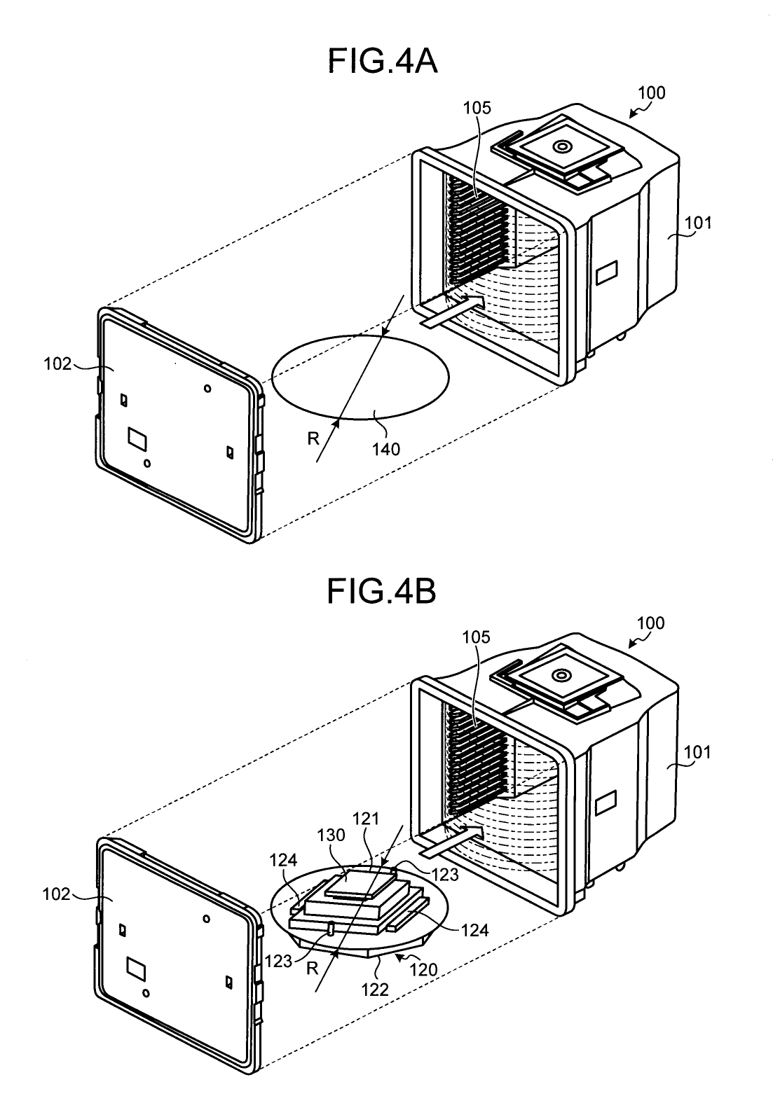

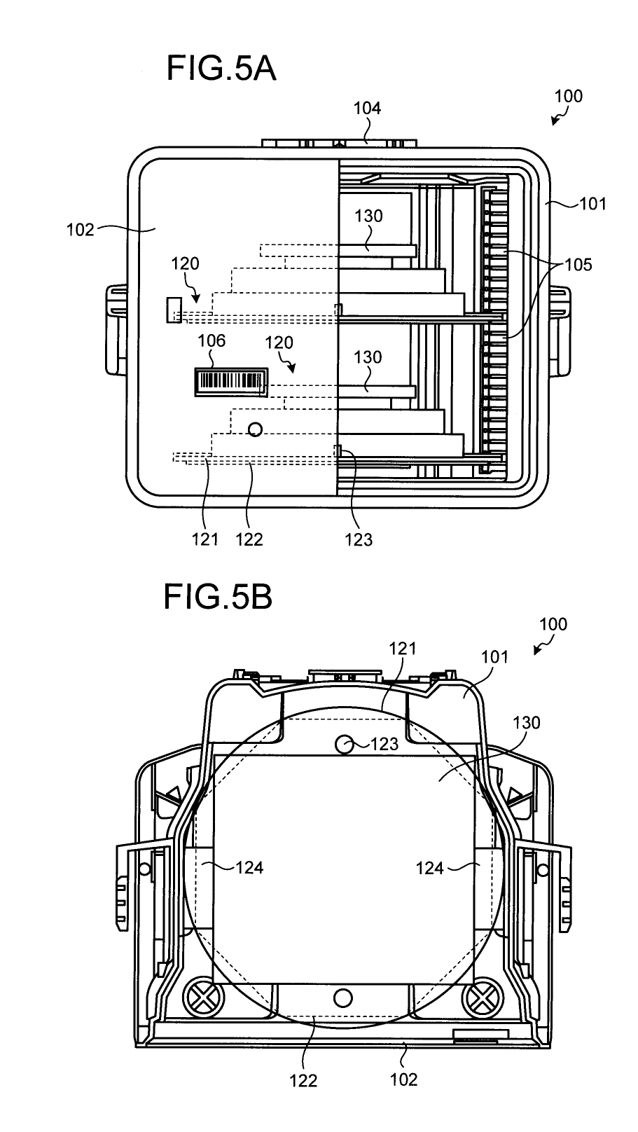

FIGS. 4A and 4B are perspective diagrams schematically illustrating states of the storage container at the time of storage. FIG. 4A illustrates a state when the wafer is stored, and FIG. 4B illustrates a state when the mask conveying adapter is stored. FIGS. 5A and 5B are diagrams illustrating states of the storage container when the mask conveying adapter is stored. FIG. 5A is a front view, and FIG. 5B is a top view. In FIG. 5A, the left half portion illustrates a state in which the cover member is attached, and the right half portion illustrates a state in which the cover member is removed.

As illustrated in the drawings, a wafer 140 and the photomask storage case 130 can be stored in the storage container 100. When the wafer 140 is stored as illustrated in FIG. 4A, the wafers having a predetermined size (a diameter R) can be stored by the number of grooves 105 formed in the storage member 101 of the storage container 100. Further, the base plate 121 of the mask conveying adapter 120 having the same size (the diameter R) as the wafer 140 is inserted into the groove 105 of the storage member 101 as illustrated FIGS. 4B, 5A, and 5B, so that the whole mask conveying adapter 120 is held inside the storage container 100. The insertion is made so that the guide bars 124 can be arranged in the vicinity of the groove 105, so that the mask conveying adapter 120 is prevented from rotating inside the storage container 100. Further, the photomask storage case 130 is fixed onto the base plate 121 by the guide bars 124 and the guide pins 123 disposed in the front to back direction of the base plate 121, so that the photomask storage case 130 is prevented from moving (position-deviated) on the base plate 121 in the front to back direction when it is moved by the conveying apparatus 200. In FIGS. 5A and 5B, the two mask conveying adapters 120 are stored in the storage container 100.

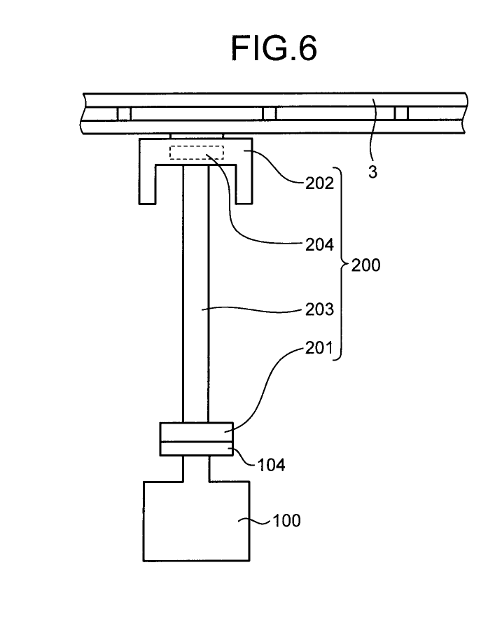

FIG. 6 is a diagram schematically illustrating an example of a structure of the conveying apparatus. Here, a description will be made in connection with a case in which a suspension conveying apparatus that is suspended from the rail 3 provided on the ceiling and moves along the rail 3 is used as the conveying apparatus 200. The conveying apparatus 200 includes a storage container holding unit 201 that is connected with the connecting portion 104 of the upper portion of the storage container 100 and holds the storage container 100, a moving mechanism unit 202 that is suspended from the rail 3 and moves along the rail 3, a rod 203 that connects the storage container holding unit 201 with the moving mechanism unit 202, and a driving mechanism unit 204 that vertically moves the storage container holding unit 201 via the rod 203.

The schematic operation of the conveying apparatus 200 having the above configuration is described. When conveying apparatus 200 does not hold the storage container 100, the conveying apparatus 200 moves the storage container holding unit 201 down to one of the stockers 11 to 71, using the driving mechanism unit 204 when the storage container holding unit 201 is moved horizontally and arrives at the position of one of the stockers 11 to 71, and so the storage container holding unit 201 is connected to the connecting portion 104 of the storage container 100. The storage container holding unit 201 is firmly fixed to the connecting portion 104 so that the storage container 100 cannot fall during the conveyance. The storage container holding unit 201 is then able to move up to a predetermined position by the driving mechanism 204. Then, the moving mechanism unit 202 moves along the rail 3 according to the instructions of the control device 80, for example, by the linear driving system.

When the conveying apparatus 200 arrives at a target stocker according to the instruction from the control device 80, the storage container holding unit 201 moves down by the driving mechanism unit 204, and the storage container holding unit 201 is removed from the connecting portion 104 of the storage container 100, so that the storage container 100 is placed in the stockers 11 to 71. Subsequently, the storage container holding unit 201 moves up to a predetermined position by the driving mechanism unit 204. In this way, the storage container 100 is conveyed by the conveying apparatus 200.

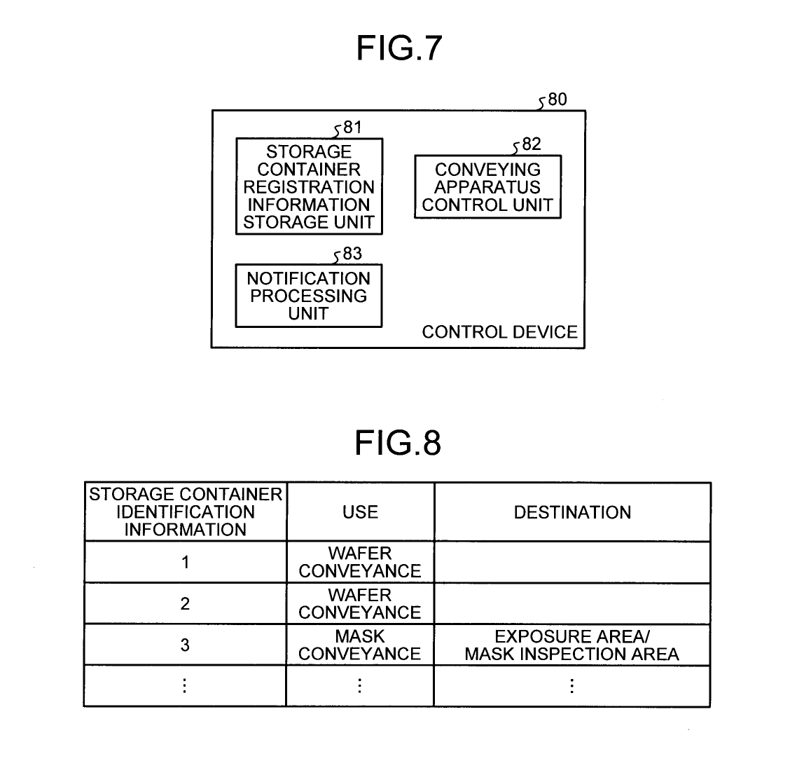

FIG. 7 is a block diagram illustrating a functional configuration of the control device according to an embodiment. Here, illustrated are functions related to a conveying process of the storage container 100 using the conveying apparatus 200. The control device 80 includes a storage container registration information storage unit 81, a conveying apparatus control unit 82, and a notification processing unit 83.

The storage container registration information storage unit 81 stores storage container registration information including use and destination of the storage container 100 used in the mask conveying system. Specifically, a use representing a wafer conveyance or a mask conveyance and a conveyance destination of the storage container 100 in the case of the mask conveyance are set to the storage container identification information uniquely attached to the storage container 100 as the storage container registration information.

FIG. 8 is a diagram illustrating an example of the storage container registration information. The storage container registration information includes the storage container identification information used for uniquely identifying the storage container within the system, the use, and the destination of the container. The information “use” defines what the storage container 100 is used for, which is specified by the storage container identification information, for example, for wafer conveyance or mask conveyance. For this reason, the storage container 100 designated for the mask conveyance by the information “use” is used only for the mask conveyance in the mask conveyance system. The destination is designated when the information “use” designates the mask conveyance, and the exposure area 30 and the mask inspection area 70 are stored as the destination.

The conveying apparatus control unit 82 has a function of conveying the storage container 100 conveyed by the conveying apparatus 200 along the rail 3 based on the storage container registration information of the storage container registration information storage unit 81. Specifically, when the read storage container identification information of the storage container 100 and the stocker identification information for identifying the stockers 11 to 71 are received from the storage container identification information reading units 12 to 72 of the stockers 11 to 71, the conveying apparatus control unit 82 decides the conveying apparatus 200 for conveying the storage container 100 stored in the stockers 11 to 71 and performs the controls based on the storage container registration information such that the storage container 100 is conveyed by the conveying apparatus 200. For example, as a decision method of the conveying apparatus 200, there is a method of selecting the conveying apparatus 200 that is closest to one of the stockers 11 to 71 storing the storage container 100 but that is not currently in use.

Further, as a control method of the conveying apparatus 200, for example, when the storage container identification information acquired from the stockers 11 to 71 has been registered to the storage container registration information as wafer conveyance information, the storage container is identified as the storage container for the wafer conveyance. The conveying apparatus control unit 82 performs the controls in such a manner that the storage container 100 is conveyed from a corresponding stocker to the next stocker according to a predetermined procedure. On the other hand, when the storage container identification information acquired from the stockers 11 to 71 has been registered to the storage container registration information as mask conveyance information, the storage container is identified as the storage container for the mask conveyance. The conveying apparatus control unit 82 specifies the current position (the exposure area 30 or the mask inspection area 70) of the storage container 100 based on the stocker identification information, acquires the position of the stocker to convey based on the storage container registration information, and performs controls for performing the conveyance to the acquired stocker position. Specifically, when the operator stores the storage container 100 for the mask conveyance in the stocker 31 in the exposure area 30, the stocker 71 in the mask inspection area 70 is designated as the destination. When the operator stores the storage container 100 for the mask conveyance in the stocker 71 in the mask inspection area 70, the stocker 31 in the exposure area 30 is designated as the destination.

When the storage container 100 has been conveyed from the exposure area 30 to the stocker 71 in the mask inspection area 70 by the conveying apparatus control unit 82 or when the storage container 100 has been conveyed from the mask inspection area 70 to the stocker 31 in the exposure area 30 by the conveying apparatus control unit 82, the notification processing unit 83 notifies an operator in or near each processing area of the fact that the storage container 100 has arrived at each processing area. Examples of a notification method include a method of installing a notification lamp in the exposure area 30 or the mask inspection area 70 and turning on the notification lamp when the storage container 100 has arrived, a method of installing a speaker in the exposure area 30 or the mask inspection area 70 and outputting a voice from the speaker when the storage container 100 has arrived, a method of notifying the operation terminals 36 and 76 installed in the exposure area 30 and the mask inspection area 70 of arrival of the storage container 100, and a method of transmitting a mail to a portable terminal when the storage container 100 has arrived when an operator has the portable terminal.

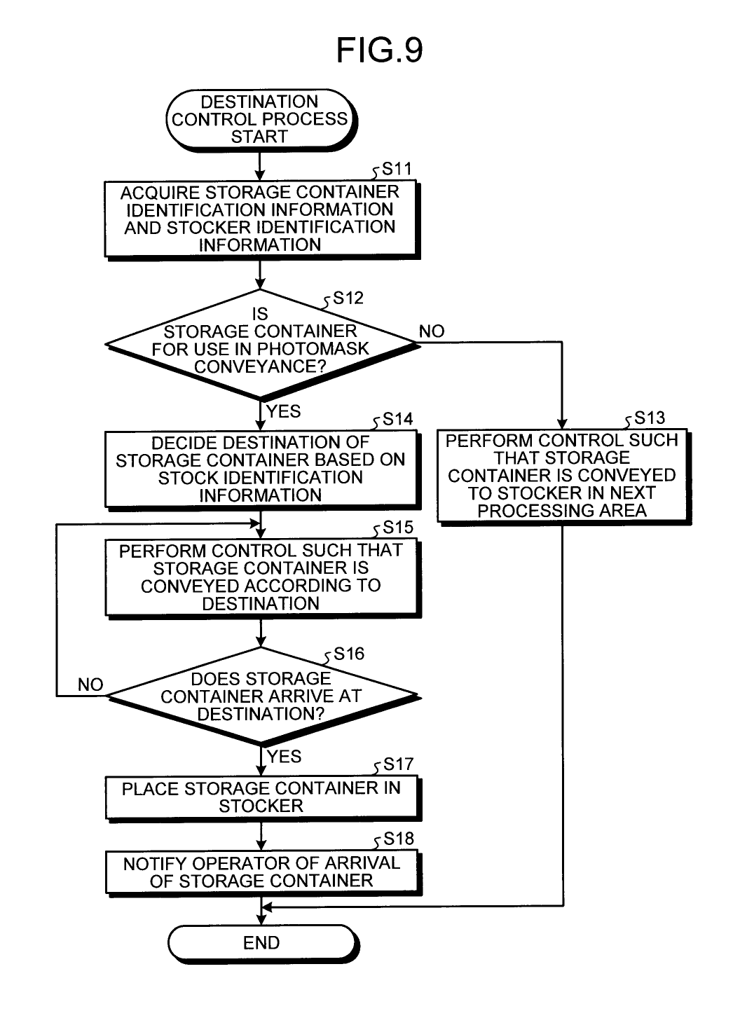

Next, a description will be made in connection with a destination control process of the storage container 100 in the mask conveying system. FIG. 9 is a flowchart illustrating an example of a procedure of a destination control process of the storage container according to an embodiment. First, when the storage container 100 is stored in each of the stockers 11 to 71 of the processing areas 10 to 70, the storage container identification information reading units 12 to 72 of the stockers 11 to 71 read the storage container identification information from the storage container identification information storage units 106 attached to the storage containers 100. Then, the read storage container identification information is transmitted to the control device 80 along with the stocker identification information of the stockers 11 to 71.

When the storage container identification information and the stocker identification information are acquired (step S11), the conveying apparatus control unit 82 of the control device 80 confirms whether or not the use of the storage container 100 corresponding to the storage identification information is the mask conveyance, based on the acquired storage container identification information and the storage container registration information stored in the storage container registration information storage unit 81 (step S12). Specifically, it is confirmed whether the use of the acquired storage container identification information has been registered to the storage container registration information as the mask conveyance information or the wafer conveyance information.

When the use of the storage container 100 is not for the mask conveyance, that is, it is for the wafer conveyance (No in step S12), the conveying apparatus 200 is controlled to convey the storage container 100 to the stocker in the next processing area (step S13). For example, when the storage container 100 is placed in the stocker 11 in the film forming area 10 of FIG. 1, the conveying apparatus 200 is controlled to convey the storage container 100 to the stocker 21 in the resist coating area 20, and then the process is finished.

On the other hand, when the use of the storage container 100 is for the mask conveyance (Yes in step S12), the destination of the storage container 100 is decided based on the acquired stocker identification information (step S14). Since the storage container 100 for the mask conveyance moves between the stocker 31 in the exposure area 30 and the stocker 71 in the mask inspection area 70, it is determined whether the stocker identification information represents the stocker 31 in the exposure area or the stocker 71 in the mask inspection area 70. Then, the stocker of the processing area other than the determined processing area is decided as the destination. Specifically, stocker 71 in the mask inspection area 70 is set as the destination when the acquired stocker identification information represents the stocker 31 in the exposure area 30, whereas the stocker 31 in the exposure area 30 is set as the destination when the acquired stocker identification information represents the stocker 71 in the exposure area 70.

Thereafter, the conveying apparatus control unit 82 controls the conveying apparatus 200 such that the storage container 100 is conveyed to the destination decided in step S14 (step S15). Then, the conveying apparatus control unit 82 determines whether or not the storage container 100 has arrived at the target stocker (step S16). When the storage container 100 has not arrived at the target stocker (No in step S16), the process returns to step S15. Further, when the storage container 100 has arrived at the target stocker (Yes in step S16), the storage container 100 is placed in the stocker (step S17). Then, the notification processing unit 83 notifies, for example, the operator in or near the destination processing area of arrival of the storage container 100 (step S18). When the storage container 100 storing the photomask has arrived at the stocker 31 in the exposure area 30, a message for notifying of arrival of the storage container 100 is displayed on a display device of the operation terminal 36 in the exposure area 30. Further, when the storage container 100 storing the photomask has arrived at the stocker 71 in the mask inspection area 70, a message for notifying of arrival of the storage container 100 is displayed on a display device of the operation terminal 76 in the mask inspection area 70. Then, the destination control process is finished.

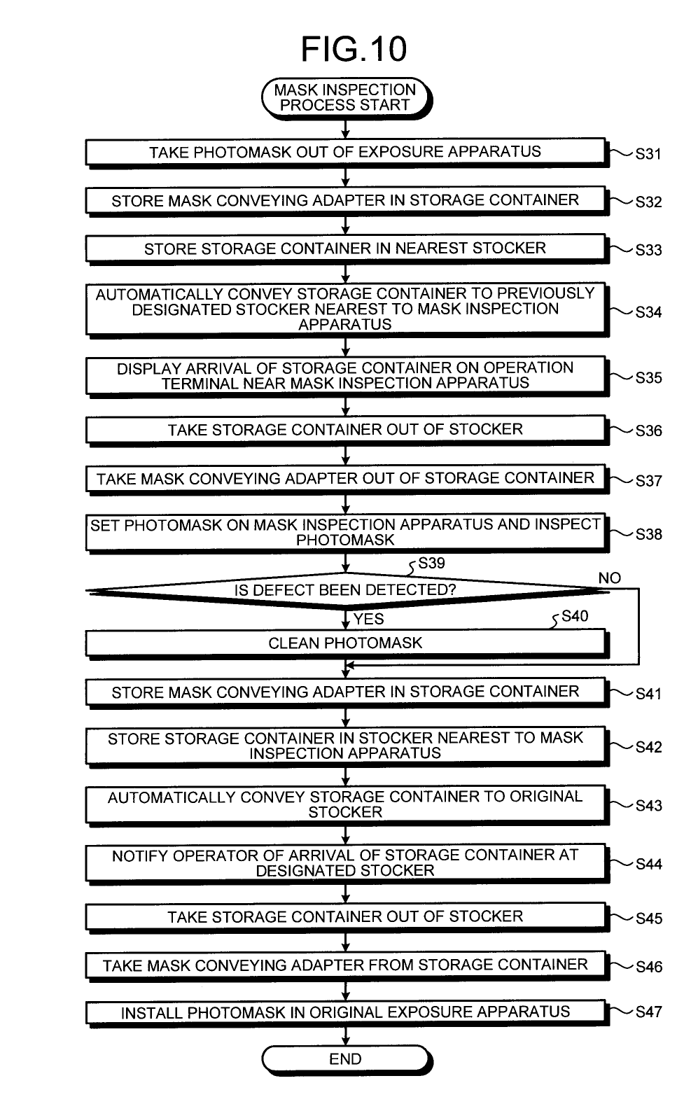

FIG. 10 is a flowchart illustrating an example of a mask inspection procedure using the mask conveying system. First, when the photomask of the exposure apparatus 33 is used in the exposure area 30 during a predetermined time period, the operator takes the photomask out of the exposure apparatus 33 in order to inspect whether or not the photomask is usable (step S31). The photomask is mounted on the mask conveying adapter 120, and the mask conveying adapter 120 is stored in the storage container 100 (step S32). Then, the operator stores the storage container 100 in the nearest stocker 31 (step S33). Since a storage container 100 is used at this time, the operator would use a storage container 100 which has been previously registered to the storage container registration information of the storage container registration information storage unit 81 for the mask conveyance.

Next, the storage container 100 is automatically conveyed from the stocker 31 in the exposure area 30 to the stocker 71 in the mask inspection area 70 by the mask conveying system (step S34). Since the storage container identification information is transmitted from the stocker 31 to the control device 80 as described above, the stocker 71 in the mask inspection area 70 is designated as the destination.

Then, when the storage container 100 arrives at the mask inspection area 70 and is placed on the stocker 71, the notification processing unit 83 of the control device 80 notifies, for example, the operation terminal 76 arranged near the mask inspection apparatus 73 of arrival of the storage container 100 storing the photomask. The operation terminal 76 outputs the arrival of the storage container 100 storing the photomask on a display unit based on the notice (step S35). Thus, the operator can recognize the arrival of the photomask to inspect. Then, the operator takes the storage container 100 out of the stocker 71 (step S36), takes the mask conveying adapter 120 out of the storage container 100 (step S37), sets the photomask on the mask inspection apparatus 73 and inspects the photomask (step S38), and determines whether or not a defects has been detected (step S39).

When the defect has been detected as a result of inspection (Yes in step S39), the inspected photomask is cleaned (step S40). Subsequently or when a defect has not been detected in step S39 (No in step S39), the mask conveying adapter 120 storing the photomask is stored in the storage container 100 by the operator (step S41), and the storage container 100 is stored in the stocker 71 nearest to the mask inspection apparatus 73 (step S42).

Next, the storage container 100 is automatically conveyed from the stocker 71 in the mask inspection area 70 to the stocker 31 in the exposure area 30 by the mask conveying system (step S43). Since the storage container identification information is transmitted from the stocker 71 to the control device 80 as described above, the stocker 31 in the exposure area 30 is designated as the destination.

When the storage container 100 arrives at the exposure area 30 and is placed on the stocker 31, the notification processing unit 83 of the control device 80 notifies, for example, the operation terminal 36 arranged near the exposure apparatus 33 of arrival of the storage container 100 storing the photomask. The operation terminal 36 outputs the arrival of the storage container 100 storing the photomask on the display unit based on the notice (step S44). Thus, the operator can recognize the arrival of the inspected photomask. Then, the operator takes the storage container out of the stocker 31 (step S45), takes the mask conveying adapter 120 out of the storage container 100 (step S46), sets the photomask on the original exposure apparatus 33 (step S47), and then, the photomask inspection procedure is finished.

The above description has been made in connection with the case in which the rails 3 are installed on the ceiling of the buildings 1A and 1B, but the present invention is not limited thereto. For example, the rail 3 may be installed on a bottom portion (on the floor) of the building. Further, the case where the stocker 71 is disposed in the mask inspection area 70 has been described, but when the rail is difficult to be installed in the mask inspection area 70, the stocker in the mask inspection area may be replaced with the stocker in the processing area near the mask inspection area 70, for example, the stocker 61 in the cleaning area 60 in FIG. 1 for convenience in design. It is similarly applied even in the exposure area 30.

In the present embodiment, the photomask is conveyed between the exposure area 30 in which the exposure apparatus 33 is located and the mask inspection area 70 in which the mask inspection apparatus 73 is located using the wafer conveying line located in the semiconductor device manufacturing facility. Thus, the photomask can be efficiently inspected without newly locating a dedicated line for conveying the photomask. Further, since the photomask is installed in the mask conveying adapter 120, the photomask can be stored in the storage container 100 for the wafer conveyance and conveyed, and the storage container for the photomask conveyance needs not be separately prepared. Thus, the cost expended for newly constructing a photomask conveying line can be significantly reduced compared to the case of newly locating the photomask conveying line. Further, compared to the case in which the photomask is completely manually conveyed between the exposure area 30 and the mask inspection area 70, the inspection time of the photomask can be reduced, and the inspection cost can be reduced. As a result, there is an effect of manufacturing the semiconductor device at a lower cost.

Further, since it is unnecessary to modify load ports of the exposure apparatus 33, the cleaning apparatus 63, and the mask inspection apparatus 73 to ones for an automatic mask conveyance line, the lower cost is achieved. Particularly, it is effective when the movement distance of the conveyance between buildings or the conveyance by a large-scale cleaning room or the like is long.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mask conveying system, comprising:
stockers that are located in processing areas in which apparatuses used in respective processes for manufacturing semiconductor devices are arranged;
a conveyance path that connects the stockers of the processing areas to one another;
a storage container that is capable of storing a predetermined number of wafers to be processed in the processing areas;
a conveying apparatus that is movable along the conveyance path and is capable of conveying the storage container; and
a control device that controls movement of the conveying apparatus on the conveyance path, wherein
the mask conveying system conveys a photomask, which is to be used in an exposure apparatus, between the exposure apparatus used in one of the manufacturing processes and a mask inspection apparatus which inspects the photomask in a manufacturing system configured to sequentially convey the storage container to the stockers of the processing areas, using the conveying apparatus,
the storage container for wafer conveyance has the same structure as the storage container for mask conveyance, and
the control device includes a conveying apparatus control unit that determines whether or not the storage container is the storage container for the mask conveyance when the storage container is introduced into in a first stocker of an exposure area in which the exposure apparatus is arranged, or into a second stocker of a mask inspection area in which the mask inspection apparatus is arranged, and that controls the conveying apparatus such that the storage container is conveyed to the second or the first stocker that is other than the stocker having the stocker introduced.

2. The mask conveying system according to claim 1, wherein
the storage container includes a storage container identification information storage unit that stores storage container identification information configured to identify an individual container,
the stocker includes a storage container identification information reading unit that reads the storage container identification information of the storage container introduced into the stocker and transmits stocker identification information attached to an own stocker along with the storage container identification information to the control device,
the control device has storage container registration information with respect to the storage container to use, the storage container registration information including the storage container identification information, use of the storage container that defines whether the storage container is for wafer conveyance or for mask conveyance, and a destination according to the use of the storage container, and
the conveying apparatus control unit of the control device compares the storage container identification information received from the storage container identification information reading unit of the stocker with the storage container registration information, determines whether or not the storage container placed in the stocker is for the mask conveyance, decides a destination of the storage container, based on the stocker identification information and the storage container registration information when the storage container placed in the stocker is for the mask conveyance, and controls a destination of the conveying apparatus that conveys the stored storage container.

3. The mask conveying system according to claim 1, further comprising a notifying unit provided in the exposure area and the mask inspection area, the notifying unit notifying an operator of the exposure apparatus or the mask inspection apparatus of arrival of the storage container when the storage container for the mask conveyance arrives at the first or second stocker.

4. The mask conveying system according to claim 1, wherein
the storage container includes a container-shaped storage member having a space capable of storing a predetermined number wafers therein and an opening that allows the wafers to be put in and taken out, and a cover member which is removable to cover the opening of the storage member and the storage member having the predetermined number of grooves formed in an inner wall of the storage member to hold edge portions of the wafers,
the photomask is stored in the storage container in a state of being mounted in a mask conveying adapter, and
the mask conveying adapter includes a bottom plate having the same size as the wafer, and a support member that is provided on a photomask mounting surface of the bottom plate and that prevents the photomask from moving on the photomask mounting surface.

5. The mask conveying system according to claim 4, wherein
the support member of the mask conveying adapter includes a pair of support members, which is provided on the bottom plate in a depth direction of the storage member when the bottom plate is held by the groove of the storage member, and a pair of support members, which is provided on the bottom plate near the grooves of the storage member, and
the support members provided near the grooves of the storage member has a shape extending in the depth direction of the storage member and is removable.

6. The mask conveying system according to claim 4, wherein
the bottom plate includes a base plate having the same size as the wafer and a back surface reinforcing plate attached to a back surface of the base plate, the back surface reinforcing plate including a plate-like member of a polygonal shape having sides that are parallel to side surfaces, in a depth direction and in a width direction, of the storage container when the bottom plate is stored in the storage container.

7. The mask conveying system according to claim 1, wherein the storage container identification information storage unit includes a bar code, a two-dimensional code, or a radio tag.

8. The mask conveying system according to claim 1, wherein the conveying apparatus control unit of the control device decides a conveying apparatus that is present nearest to the stocker into which the storage container is introduced and is not conveying the storage container as a conveying apparatus to convey the stocker having the storage container introduced when the storage container is introduced into the stocker.

9. A mask conveying adapter to be stored in a storage container that includes a container-shaped storage member having a space capable of storing a predetermined number wafers and an opening that allows the wafers to be put in and taken out, and a cover member which is removable to cover the opening of the storage member and the storage member having the predetermined number of grooves that are provided in an inner wall of the storage member and holding edge portions of the wafers, the mask conveying adapter comprising,
a bottom plate having the same size as the wafer; and
a support member that prevents the photomask from moving on a mounting surface that is a side of the bottom plate at which the photomask is mounted.

10. The mask conveying adapter according to claim 9, wherein
the support member includes a pair of support members provided on the bottom plate in a depth direction of the storage member when the bottom plate is held by the groove of the storage member and a pair of support members provided on the bottom plate near the grooves of the storage member, and
the support members provided near the grooves of the storage member has a shape extending in the depth direction of the storage member and is removable.

11. The mask conveying adapter according to claim 9, wherein the bottom plate includes a base plate having the same size as the wafer and a back surface reinforcing plate attached to a back surface of the base plate, the back surface reinforcing plate including a plate-like member of a polygonal shape having sides that are parallel to side surfaces, in a depth direction and in a width direction, of the storage container when the bottom plate is stored in the storage container.
